(19) United States
(12) Patent Application Publication
(10) Pub. No.: US 2002/0046150 A1
(43) Pub. Date: Apr. 18, 2002

(54) Brokering system

(76) Inventor: Joerg Haehle, Munich (DE)

Correspondence Address: FRANK R. OCCHIUTI, Fish & Richardson P.C., 225 Franklin Street, Boston, MA, 02110-2804, US

(21) Appl. No.: 09/853,243

(22) Filed: May 11, 2001

(30) Foreign Application Priority Data
May 12, 2000 (DE) DE10023359.7

(51) Int. Cl. G06F 17/60

(52) U.S. Cl. 705/37

(57) ABSTRACT

A brokering facility, which can be connected to a voice communication network, includes recording means for recording, under voice menu control, tender information from any tenderers calling via the voice communication network, and a database for storing the tender information. The brokering facility also includes requesting means for any parties calling via the voice communication network to request, under voice menu control, tender information stored in the database.

### CLAIM TO PRIORITY

This application claims priority from German Application No. DE10023359.7, filed on May 12, 2000, the contents of which are hereby incorporated by reference into the subject application as if set forth herein in full.

### BACKGROUND

The invention relates to a brokering system for conveying tenders from various tenderers to interested parties for these tenders. In this context, tenders may be regarded as any business or private tenders, such as sales, rental or purchase tenders for goods of any type.

Brokering systems implemented on Internet servers are generally known. Normally, such brokering systems provide Web pages into which various tenderers can enter their tenders, possibly directly over the Internet. By retrieving these Web pages over the Internet, any interested parties can then retrieve the tender information entered by the tenderers.

However, retrieving the tender information requires that the interested party have complex hardware equipment with Internet access implemented. These are not available to everyone. Internet access is currently most often provided by personal computers installed at a fixed location. To be able to retrieve tender information irrespective of the present location, e.g., on business trips or the like, it is necessary to have additional, mobile Internet access, e.g., by means of a laptop computer or a mobile radio with WAP (Wireless Application Protocol) capability.

Laptop computers can be comparatively expensive and unwieldy, however. In addition, a connection to a feeder communication network is necessary to access the Internet. This means that there is only very limited opportunity to retrieve tender information posted on the Internet while en route, e.g., in order to obtain information about available hotel rooms on the spot.

By contrast, a mobile radio with WAP capability also allows direct Internet access while en route, but only to Web pages which are based on the WAP protocol. At the present time, the proportion of WAP-compliant Web pages on the Internet and of tenders which can be retrieved thereby is still very small, however.

### SUMMARY

It is an object of the present invention to specify a brokering facility and a brokering system that provide a simple opportunity for tender information originating from various tenderers to be recorded and to be requested by various interested parties.

This object is achieved by a brokering facility in accordance with patent claim 1 and by a brokering system in accordance with patent claim 15.

An inventive brokering facility or an inventive brokering system makes it possible to record tender information from any tenderers calling via a voice communication network. The recorded tender information can then be respectively requested by any interested parties simply by calling via the voice communication network. The tender information is recorded and requested under voice menu control. This means that menu information is transmitted to a respective caller in spoken form or in a form produced by a voice synthesis device. The caller can use the transmitted menu information to select one or more menu options, e.g., by an entry onto the control panel of his terminal or by means of voice input spoken by the caller, i.e., by active voice control.

One fundamental advantage of the invention is that both tenderers and interested parties can use the brokering facility in a particularly simple manner via a voice communication network, such as a public telephone network (PSTN) or a mobile radio network. Thus, by way of example, an interested party can also call an inventive brokering facility from a car using a conventional mobile terminal in order to request from the brokering facility room tenders, for example, from hotels located in the vicinity.

In addition, an inventive brokering facility requires only a very low level of administrative effort, since tenders are both recorded and retrieved automatically in essence.

Advantageous embodiments and developments of the invention are specified in the dependent claims.

In accordance with one advantageous development of the invention, the tender information can be divided up into different tender categories, such as hotel room tenders, used car tenders, apartment tenders etc., in the database of the brokering facility. The tender categories can be prescribed, by way of example, by the operator of the brokering facility, or else can be set up by tenderers, possibly under menu control. To record or request tender information in a particular tender category, the tenderer or interested party concerned can use the brokering facility to request, under menu control, an item of selection information which identifies the tender category.

In accordance with one development of the invention, the brokering facility can have localization means for detecting the location of a caller and for controlling the brokering facility on the basis of the detected location of the caller. For a call via a landline network, the caller can be localized using the caller's area code transmitted to the brokering facility, for example. For calls via a mobile radio network, the area in which the mobile radio terminal used has registered with the mobile radio network can be requested from the mobile radio network by the brokering facility using the mobile radio terminal's transmitted telephone number. In addition, data from a GPS (Global Positioning System) receiver of the caller can also be requested and evaluated by the brokering facility in order to ascertain the location of the caller. The tender information can then be recorded or requested on the basis of the ascertained location of a caller. This makes it possible, by way of example, to offer an interested party for selection tenders which are preferably relevant to his location or tenders sorted according to the distance from his location.

According to another advantageous embodiment of the invention, the brokering facility can have authentication means for checking an item of authentication information, e.g. a PIN (Personal Identification Number), which needs to be entered by a calling tenderer. In this context, the item of authentication information needs to be entered by the tenderer in order to gain write and/or modification access to the database of the braking device. If appropriate, provision may also be made for calling interested parties to be authenticated, for example in order to enable, preferably, read access to tenders which are not publicly accessible for calling interested parties in each case after an appropriate item of authentication information has been entered.

According to another advantageous development, the brokering facility can also have detection means for detecting connection identification information, e.g., callers' telephone numbers, and a database in which a respective item of call identification information from a caller has an associated individual item of user profile information. This means that once the connection identification information from a caller has been detected, the brokering facility can access the respectively associated item of user profile information and, on the basis of this, can record or request tender information. In this way, an interested party identified by a detected item of connection identification information can be offered a tender spectrum specifically tailored to this interested party for selection.

According to another advantageous embodiment of the invention, once a tender has been selected by an interested party, a connection to the tenderer of this tender can immediately be set up by the brokering facility. As an alternative to this, a telephone number for the tenderer can be transmitted to the interested party.

In addition, the brokering facility can be provided with logging means, which are used to log access operations to tender information from a tenderer. The logged access information can then be requested by the tenderer concerned, possibly after entry of an item of authentication information. This allows the tenderer to obtain information about the demand for his tenders.

An illustrative embodiment of the invention is explained in more detail below with the aid of the drawings.

### DESCRIPTION OF DRAWINGS

FIG. 1 shows a schematic illustration of a brokering facility, connected to a voice communication network, recording a tender from a tenderer whose is calling via the voice communication network.

FIG. 2 shows a schematic illustration of the same brokering facility when an interested party calling via the voice communication network is requesting a tender.

FIG. 3 shows a schematic illustration of a flowchart to illustrate a typical procedure for recording a tender.

FIG. 4 shows a schematic illustration of a flowchart to illustrate a typical procedure for requesting a tender.

### DESCRIPTION

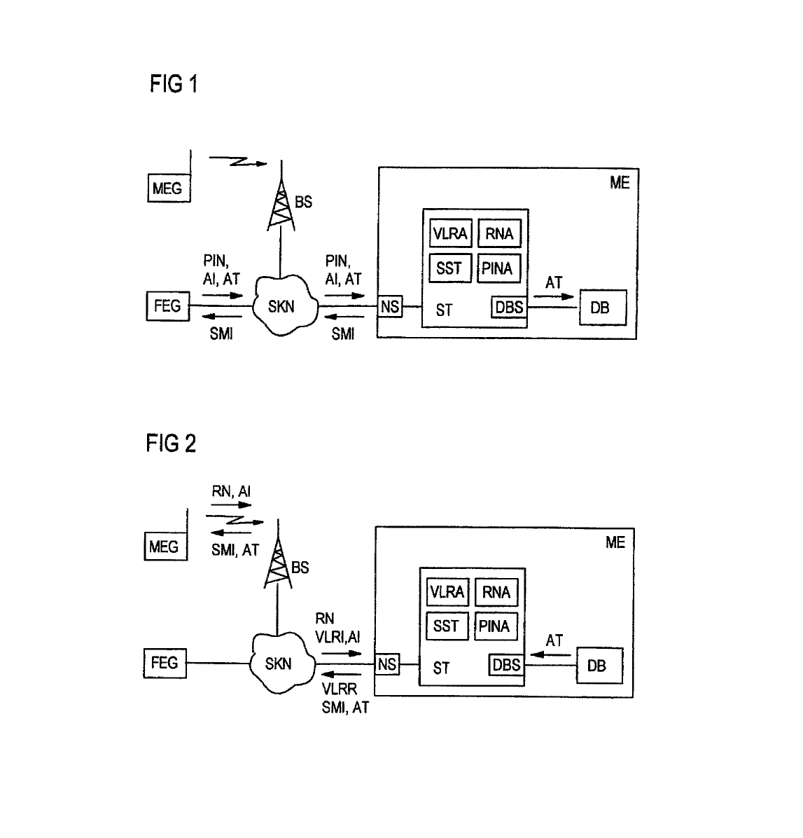

FIGS. 1 and 2 each show a brokering facility ME connected to a voice communication network SKN, e.g. a public telephone network. The brokering facility ME, which can be in the form of a “call server”, for example, has an associated telephone number which can be used to call the brokering facility ME via the voice communication network SKN. Such a call can be made from any terminals that can be connected to the voice communication network SKN. As examples of such terminals, FIGS. 1 and 2 show a landline network terminal FEG connected to the voice communication network SKN, and a mobile terminal MEG. In this case, the mobile terminal MEG can be coupled wirelessly—as indicated by a stylized flash—to a mobile radio base station BS, which, for its part, is coupled to the voice communication network SKN.

The functional components of the brokering facility ME are a control device ST, a database DB, which is connected to the control device ST, and a network interface NS, which is likewise connected to the control device ST. The control device ST is coupled to the voice communication network SKN via the network interface NS. For its part, the control device ST has a database interface DBS, via which the database DB is connected, a voice menu control device SST, a telephone number evaluation device RNA, a VLR evaluation device VLRA (Visitor Location Register) and a PIN evaluation device PINA (Personal Identification Number).

FIG. 1 shows the brokering facility ME recording a tender from a tenderer who is calling from an arbitrary terminal, in this case the landline network terminal FEG. For this purpose, the tenderer dials the telephone number of the brokering facility ME, and a connection is then set up from the landline network terminal FEG to the brokering facility ME via the voice communication network SKN. In accordance with one particularly advantageous embodiment of the invention, the brokering facility ME can be contacted on a telephone number that is standard throughout a country, Europe or the world, for example. Provision may also be made for a telephone number, transmitted in the course of the connection being set up to the brokering facility ME, for the tenderer to be evaluated by the telephone number evaluation device RNA in order to ascertain the location of the tenderer, e.g. using the area code of this telephone number. Once the tenderer has been localized, his call can be forwarded by the brokering facility ME to a local brokering facility (not shown), which is responsible for the location of the tenderer. It may be assumed below, for the sake of clarity, that the brokering facility ME is actually the brokering facility which is responsible for the location of the tenderer.

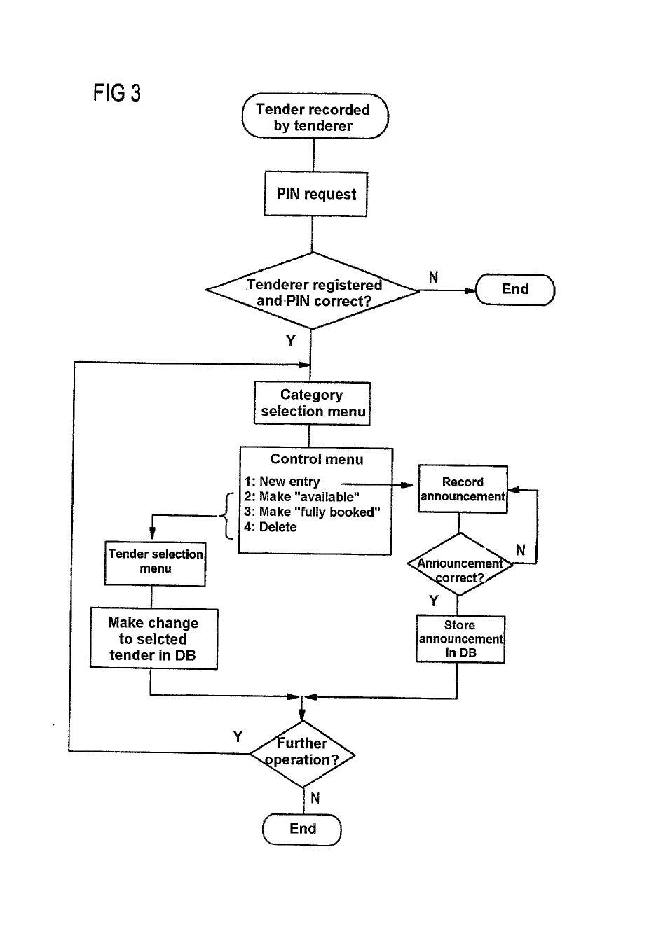

Expanding on FIG. 1, FIG. 3 uses a flowchart to illustrate the flow of a tender being recorded in typical fashion by the tenderer. Once the connection between the tenderer and the brokering facility ME has been set up, the control device ST requests an item of authentication information, in the form of a PIN, which needs to be entered by the tenderer. Using the PIN which is then entered by the tenderer, the PIN evaluation device PINA checks whether the tenderer is registered with the brokering facility ME and whether the PIN number PIN is correct. If the result of the check is negative, the connection is terminated, possibly after an appropriate announcement has been output.

A new tenderer can be registered in a wide variety of ways, e.g., by written application to the operator of the brokering facility, by registration using an Internet Web page of the operator or by means of a prior call to the brokering facility ME and registration under voice menu control. When a new tenderer is registered, he is allocated a unique PIN number which is specific to the tenderer and subsequently needs to be entered whenever a tender is recorded or modified.

After the tenderer has been successfully authenticated by means of the entered PIN number PIN, the tenderer is guided through a category selection menu by the voice menu control device SST. The form taken by menu guidance is that the voice menu control device SST outputs to the tenderer the selection menu's entries which can be selected as alternatives as voice menu information SMI in the form of spoken or synthesized language. The tenderer can then select a menu entry, for example, by pressing a button on the control panel of his terminal or by means of voice input. Voice input by the tenderer can be evaluated by a voice recognition device in the voice menu control device SST.

The voice menu control device SST first prompts the tenderer to select the category to which the tender to be recorded belongs. In this context, the tender categories provided may be quite different, such as available hotel rooms, available parking spaces in multistory car parks, used cars, etc. For the present illustrative embodiment, it may be assumed that the tenderer wishes to tender available hotel rooms. Once the appropriate tender category has been selected, the tenderer may possibly also be guided through one or more selection menus for selecting subcategories. A tender category or tender subcategory can also be selected on the basis of the entered PIN number PIN.

The tenderer then enters a control menu which comprises, possibly on the basis of the respective category or subcategory selected, the menu entries ‘1: New entry’, ‘2: Make “available”’, ‘3: Make “fully booked”’ and ‘4: Delete’. The voice menu control device SST reads these menu entries aloud to the tenderer, who then selects a menu item by pressing one of the buttons 1 to 4 on his landline network terminal FEG or by entering one of the numbers 1 to 4 by means of voice input. In this context, an item of signaling information which identifies the button pressed, or the number spoken by the tenderer, is transmitted to the control device ST as item of selection information AI.

If menu item ‘1: New entry’ is selected, the tenderer is asked to give a spoken announcement AT which specifies his tender and is recorded by the control device ST. The recorded announcement is then output to the tenderer for monitoring purposes, and the tenderer's acceptance of this announcement is requested under voice menu control. If acceptance is indicated, the announcement AT is stored in the database DB. Otherwise, a new announcement is recorded. The tenderer is then given the option of returning to the category selection menu or of terminating the recording of a tender.

The announcement AT is preferably stored within a tender data record which represents an individual tender and preferably comprises a tenderer identifier, which identifies the respective tenderer, a category identifier, which identifies the respective category or subcategory, a serial tender number and the respective tender text AT as a voice file. For each individual tenderer, the database DB can also store a tenderer data record which may preferably comprise the tenderer identifier, the name of the tenderer, his telephone number, his PIN number and an item of location information indicating the location of the tenderer.

If one of the control menu's tender-modifying menu items 2, 3 or 4 is selected, the tenderer is guided through a tender selection menu SST by the voice menu control device SST. As part of this tender selection menu, at least extracts of all the tenders in the selected category or subcategory which have already been stored in the database by the tenderer are read aloud to the tenderer. The tenderer then selects one of these tenders by entering an item of selection information, and the change selected in the control menu is then made to the selected tender. In the present illustrative embodiment, entering the item of control information 2 makes a hotel room tender available, entering the item of control information 3 marks a hotel as full, and entering the item of control information 4 deletes the room tender concerned. The tenderer is then given the option of returning to the category selection menu or of terminating the recording of a tender.

As an alternative to recording a tender via the voice communication network SKN, a tender can also be recorded over the Internet, e.g. by entering the tender into a Web page provided for this purpose by the operator of the brokering facility ME. Tenders recorded over the Internet are likewise stored in the database DB.

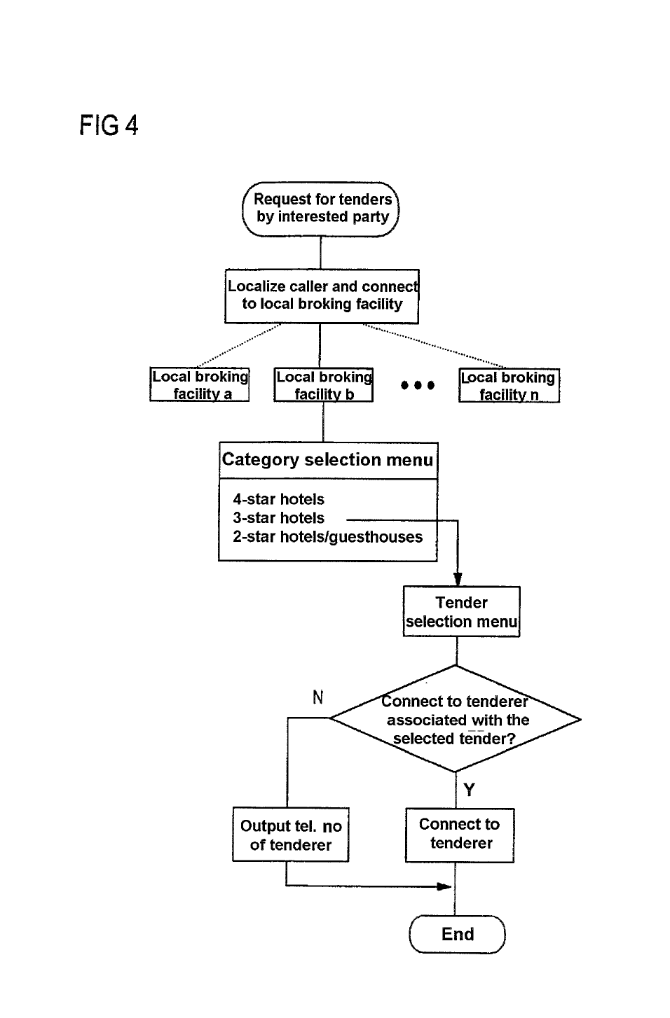

FIG. 2 shows the brokering facility ME when tenders are being requested by an interested party calling from an arbitrary terminal, in this case the mobile terminal MEG. Expanding on this, FIG. 4 uses a flowchart to illustrate the flow of a request for tenders. To request tenders, an interested party directs a call via the voice communication network SKN to the brokering facility ME, which can preferably be contacted using a standard telephone number. When the call is received, the interested party is first localized using the VLR evaluation device VLRA, and the brokering facility ME connects him to a local brokering facility which is responsible for the ascertained location of the interested party. In the present illustrative embodiment, it may be assumed, for reasons of clarity, that the brokering facility ME itself is responsible for the location of the interested party. To localize the interested party, the VLR evaluation device VLRA uses his telephone number RN transmitted to the brokering facility ME in the course of connection set-up to send a VLR request message VLRR to the mobile radio network of the interested party. In the present illustrative embodiment, this mobile radio network is regarded as part of the voice communication network SKN. The VLR request message VLRR interrogates the “Visitor Location Register” of the mobile radio network, as a result of which an item of VLR information VLRI indicating the location of the interested party is transmitted from the mobile radio network to the brokering facility ME. This item of VLR information VLRI is evaluated by the VLR evaluation device VLRA in order to localize the mobile terminal MEG.

Interested parties calling via a landline network terminal can be localized by virtue of the telephone number evaluation device RNA evaluating their telephone number RN transmitted to the brokering facility ME.

Having been put through to the brokering facility ME that has local responsibility for the interested party, the interested party is guided through a category selection menu by the voice menu control device SST. For the present illustrative embodiment, it may be assumed that the interested party selects the “hotel reservation” category, whereupon the interested party is guided to another selection menu in order to select a subcategory. In this case, the subcategories that the voice menu controller SST offers to the interested party are 4-star hotels, 3-star hotels and 2-star hotels/guesthouses. When a subcategory desired by the interested party has been selected, in this case the subcategory “3-star hotels”, for example, the interested party is guided through a tender selection menu. In this tender selection menu, those room tenders for all 3-star hotels that have been marked as available by the respective tenderers and are located in the vicinity of the interested party are output to the interested party on the basis of the detected item of VLR information VLRI. As the room tenders are output, the respective stored tender text AT is transmitted to the interested party. In this case, the distance between a tenderer associated with a respective tender and the interested party can be determined on the basis of the location information stored in the tenderer's tenderer data record. If appropriate, the room tenders can be output sorted based on the distance between tenderer and interested party.

A menu item is selected by the interested party in a similar way to that in which a menu is selected by a tenderer, as described above, in that the interested party enters on the mobile terminal MEG an item of selection information AI which is transmitted to the brokering facility ME and is evaluated by the voice menu control device SST.

So that the interested party can also be deliberately offered tenders which are specific to the interested party, the database DB can store and manage for the interested party a respective interested party data record containing a user profile for the interested party concerned. In this context, the user profile is preferably assigned to the telephone number RN of the interested party in question. Accordingly, when an interested party calls, the interested party's telephone number RN transmitted to the brokering facility ME is used to search the database DB for a user profile associated with this telephone number RN. Provided that a user profile for the interested party is ascertained in this way, the category and tender selection menus can be configured and output for the specific interested party on the basis of the user profile ascertained. Whenever an interested party calls, his user profile can be updated on the basis of his requesting behavior.

Once the interested party has selected a specific tender, the interested party is given the option of setting up a direct connection to the tenderer of the selected tender. If the interested party decides on a direct connection to the tenderer by entering and transmitting an appropriate item of selection information AI, the direct connection is set up by the brokering facility ME. Otherwise, the telephone number of the selected tenderer is merely output and the connection to the interested party is then terminated.

The tender requests made by the interested party can be logged, possibly for specific tenderers or tenders, by the brokering facility ME. The brokering facility ME can keep the log information obtained in this manner ready for request by a respective tenderer via the voice communication network SKN or possibly via the Internet.

In addition, the voice menu control may also be implemented in a number of languages. In this case, a language selection menu is preferably provided for selecting a particular language. Other embodiments not specifically described herein are within the scope of the following claims.

What is claimed is:

1. A brokering facility for recording and outputting tender information via a voice communication network, the brokering facility comprising:
recording means for recording, under voice menu control, tender information from tenderers calling via the voice communication network;
a database for storing recorded tender information;
requesting means for parties calling via the voice communication network to request, under voice menu control, tender information stored in the database, the tender information being available to various parties; and
outputting means for outputting the requested tender information to a requesting party.

2. The brokering facility of claim 1, comprising:
a voice menu control device for requesting, under voice menu control, control information from a tenderer and/or a party calling via the voice communication network.

3. The brokering facility of claim 2, wherein the recording means and/or the requesting means comprises selecting means for selecting an item of tender information based on an item of selection information contained in requested control information.

4. The brokering facility of claim 2 or 3, wherein the tender information comprises different tender categories in the database, and wherein the recording means and/or the requesting means comprise selecting means for selecting a tender category based on selection information contained in requested control information.

5. The brokering facility of claim 1 further comprising:
means for detecting a location of a caller and for controlling the brokering facility based on of a detected location of the caller.

6. The brokering facility of claim 5, wherein the recording means records, under voice menu control, tender information from a tenderer based on a detected location of the tenderer.

7. The brokering facility of claim 5 or 6, wherein the requesting means requests, under voice menu control, tender information based on a detected location of the interested party.

8. The brokering facility of claim 1, further comprising:
authentication means for verifying an item of authentication information that is entered by a calling tenderer and for granting access authorization to the tenderer if the authentication information is verified.

9. The brokering facility of claim 1, further comprising:
detecting means for detecting connection identification information from callers, and a database in which an item of connection identification information from a caller has an associated individual item of user profile information.

10. The brokering facility of claim 9, wherein the recording means records, under voice menu control, tender information based on stored user profile information associated with a detected item of connection identification information from a tenderer.

11. The brokering facility of claim 9 or 10, wherein the requesting means requests, under voice menu control, tender information on the basis of stored user profile information associated with a detected item of connection identification information from a party.

12. The brokering facility of claim 1, further comprising:
a switching device for setting up a connection between a party and a tenderer of an item of tender information selected by the party.

13. The brokering facility of claim 1, further comprising:
logging means for logging access operations to tender information from a tenderer and for outputting logged access information to the tenderer.

14. The brokering facility of claim 1, further comprising:
bydebiting means for detecting access operations to the brokering facility and for debiting charges for individual tenderers and/or interested parties based on detected access operation

15. A brokering system comprising:
a plurality of brokering facilities according to claim 1, each brokering facility further comprising:
means for detecting a location of a caller; and
a switching device for setting up a connection between the caller and a one of the brokering facilities that detects the location of the caller.
